(19) United States
(12) Patent Application Publication
(10) Pub. No.: US 2012/0228449 A1
(43) Pub. Date: Sep. 13, 2012

(54) ROTARY HANGING TAG

(76) Inventor: Shi-Yu SUN, Shanghai (CN)

(21) Appl. No.: 13/163,846

(22) Filed: Jun. 20, 2011

(30) Foreign Application Priority Data
Mar. 10, 2011 (CN) 201120061046.6

(51) Int. Cl. F16M 13/02; F16M 13/00

(52) U.S. Cl. 248/224.8; 248/309.1

(57) ABSTRACT

A rotary hanging tag comprises a hanging plate and a support frame. The hanging plate includes a principal plane of a curved surface formed by bending a front end of the hanging plate towards an internal side of the hanging plate, and the hanging plate passes through a slot formed on the curved surface and pivotally coupled to a first spindle of the support frame for rotating around the first spindle. The support frame includes a hanging compartment disposed at the bottom of a front end of the support frame and formed by a compartment body and a fastener corresponding to the compartment body. The rotary hanging tag can be folded to facilitate transportations and hung at different positions for accessing tools to release the binding to a user's body and enhance safety and efficiency. In addition, the rotary hanging tag has an integral structure to lower production cost.

### BACKGROUND OF THE INVENTION

1. Field of the Invention

The present invention relates to a rotary hanging tag.

2. Description of Related Art

In general, technicians have to carry various kinds of tools with them for work, and most of the time, these tools are used alternately, but the technicians usually have no place to put extra tools or fail to find the desired tool when needed.

### SUMMARY OF THE INVENTION

In view of the aforementioned problems, it is a primary objective of the present invention to provide a rotary hanging tag to overcome the deficiencies of the prior art.

To achieve the foregoing objective, the present invention provided the following technical solution:

The invention provides a rotary hanging tag comprising a hanging plate and a support frame, and the hanging plate includes a principal plane of a curved surface formed by bending a front end of the hanging plate towards an internal side of the hanging plate, and the hanging plate passes through a slot formed on the curved surface and pivotally coupled to a first spindle of the support frame for rotating around the first spindle. The support frame includes a hanging compartment disposed at the bottom of a front end of the support frame and formed by a compartment body and a fastener corresponding to the compartment body.

Preferably, the fastener has an end passing through a second spindle pivotally coupled to the compartment body and another end of the fastener passing through a latch latched onto a first protrusion of the compartment body.

Preferably, the support frame contains a hanging rod installed on the compartment body.

Preferably, the curve surface of the hanging plate has a plurality of second protrusions disposed uniformly around the slot, and the first spindle of the support frame has a plurality of notches formed at the periphery of the first spindle and corresponding to the second protrusions respectively.

Preferably, the hanging plate has a hanging hole formed thereon.

With the foregoing technical solution, the rotary hanging tag of the present invention can be folded to facilitate transportations, and hung at different positions for accessing tools to release the binding to a user's body and enhance safety and efficiency. In addition, the rotary hanging tag has an integral structure to lower production cost.

### BRIEF DESCRIPTION OF THE DRAWINGS

FIG. 1 is a schematic view of the present invention;

FIG. 2 is a side view of the present invention;

FIG. 3 is a bottom view of the present invention;

FIG. 4 is a schematic view of the present invention without a fastener;

FIG. 5 is a schematic view of a fastener of the present invention;

FIG. 6 is a schematic view of a hanging plate of the present invention;

FIG. 7 is a schematic view of a support frame of the present invention; and

FIG. 8 is a schematic view of an application of the present invention.

### DETAILED DESCRIPTION OF THE PREFERRED EMBODIMENTS

Understanding of the present invention will be facilitated by consideration of the detailed description of the following preferred embodiments of the present invention, taken in conjunction with the accompanying drawings.

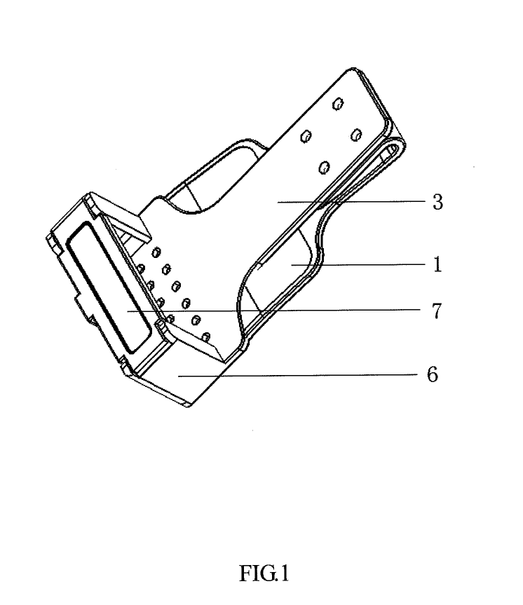

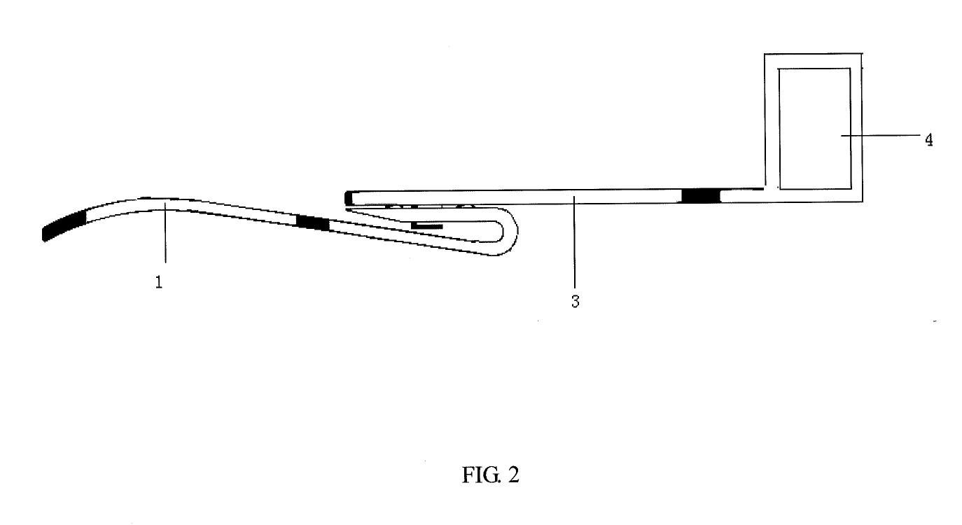

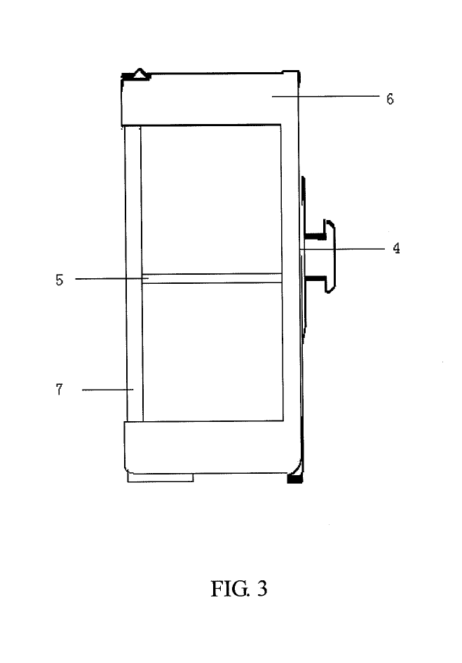

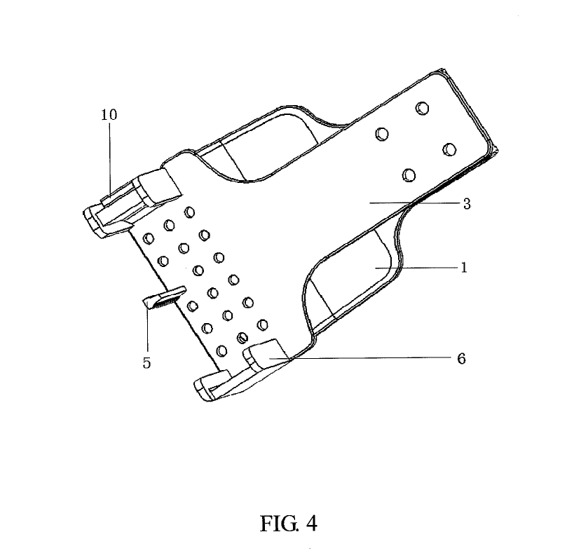

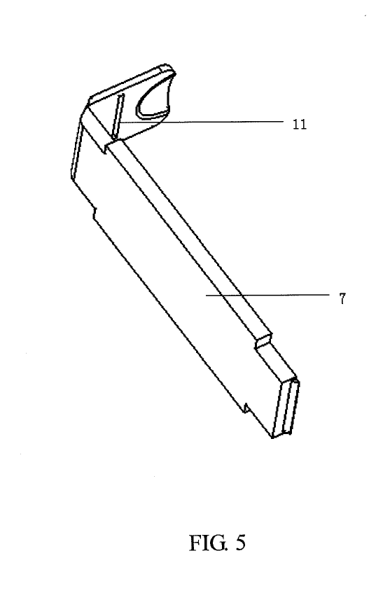

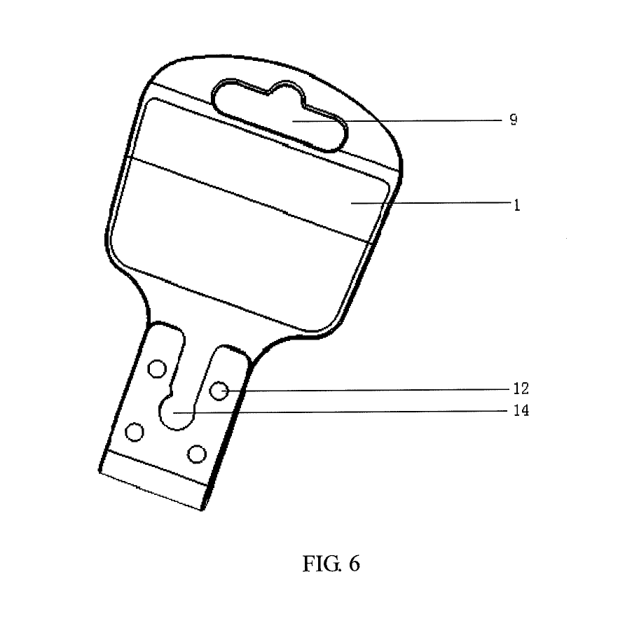

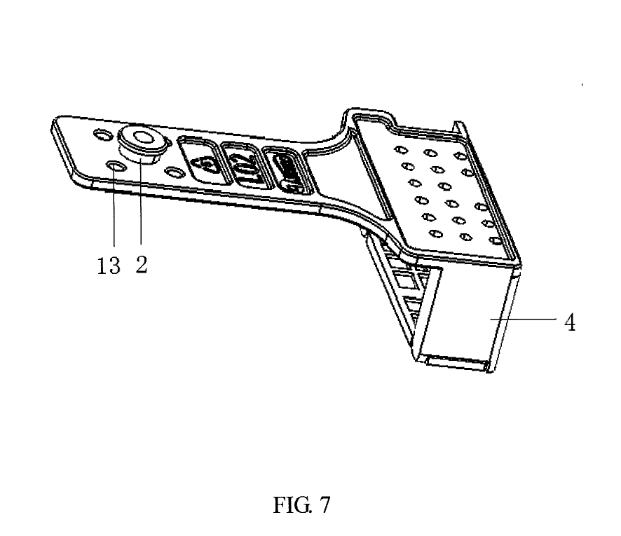

With reference to FIGS. 1 to 7 for a rotary hanging tag of the present invention, the rotary hanging tag comprises a hanging plate 1 and a support frame 3. The hanging plate 1 comprises: a principal plane; a curved surface formed by bending a front end of the principal plane towards an internal side; a slot 14 formed on the curved surface of the hanging plate 1, wherein the hanging plate 1 is passed through the slot 14 pivotally coupled to a first spindle 2 of the support frame 3 and can be rotated in any angle around the first spindle 2; and a plurality of second protrusions 12 disposed uniformly around the periphery of the slot 14 on the curved surface of the hanging plate 1, wherein the first spindle 2 has a plurality of notches 13 formed around the periphery of the first spindle 2 and corresponding to the plurality of second protrusions 12 respectively.

The support frame 3 includes a hanging compartment 4 disposed at the bottom of a front end of the support frame 3, and the hanging compartment 4 is comprised of a compartment body 6 and a fastener 7 corresponding to the compartment body 6. An end of the fastener 7 is passed through a second spindle pivotally coupled to the compartment body 6, and another end of the fastener 7 is passed through a latch 11 latched onto a first protrusion 10 of the compartment body 6. The hanging plate 1 has a hanging hole 9 formed thereon, and the compartment body 6 of the hanging compartment 4 of the support frame 1 includes a hanging rod 5 installed therein.

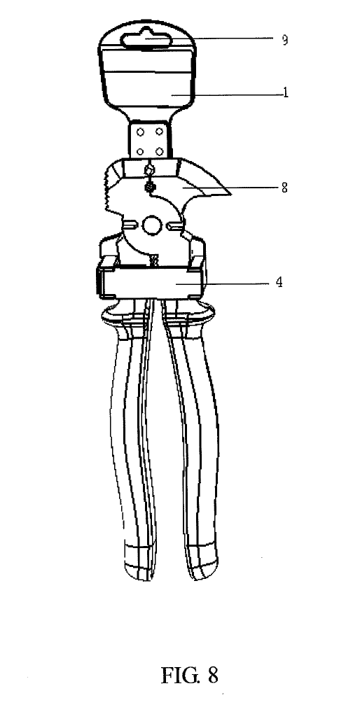

With reference to FIG. 8 for an application of the present invention, the fastener 7 is removed from a latch end of the compartment body 6, and the fastener 7 is rotated around the second spindle to a certain angle, such that a tool which is a pair of forceps in this preferred embodiment is put into the hanging compartment 4 and rested on the hanging rod 5, and then the latch 11 of the fastener 7 is latched onto the first protrusion 10 of the compartment body 6 securely. When the hanging plate 1 is rotated around the first spindle 2 by 180 degrees to a position below the hanging hole 9, the second protrusion 12 on the hanging plate 1 and the notch 14 on the support frame 3 are latched securely to achieve a position limiting effect to prevent the tool from shaking or swinging. With the curved surface of the hanging plate 1, the rotary hanging tag can be hung around a user's waist to facilitate the user to access the tool while working at a high altitude. When the hanging plate 1 is rotated around the first spindle 2 to a position above the hanging hole 9, the second protrusion 12 on the curved surface of the hanging plate 1 and the notch 14 on the support frame 3 are latched to achieve the position limiting effect, such that the rotary hanging tag can be hung at other positions through the hanging hole 9 to meet different requirements.

While the invention has been described by means of specific embodiments, numerous modifications and variations could be made thereto by those skilled in the art without departing from the scope and spirit of the invention set forth in the claims.

What is claimed is:

1. A rotary hanging tag, comprising:
a hanging plate, having a principal plane of a curved surface formed by bending a front end of the hanging plate towards an internal side of the hanging plate, and the hanging plate passing through a slot formed on the curved surface and pivotally coupled to a first spindle of a support frame, for rotating around the first spindle; and
the support frame, having a hanging compartment disposed at the bottom of a front end of the support frame, and the hanging compartment being formed by a compartment body and a fastener corresponding to the compartment body.

2. The rotary hanging tag of claim 1, wherein the compartment body contains a hanging rod installed on the support frame.

3. The rotary hanging tag of claim 1, wherein the fastener has an end passing through a second spindle pivotally coupled to the compartment body, and another end of the fastener passing through a latch latched onto a first protrusion of the compartment body.

4. The rotary hanging tag of claim 3, wherein the compartment body contains a hanging rod installed on the support frame.

5. The rotary hanging tag of claim 4, wherein the curve surface of the hanging plate has a plurality of second protrusions disposed uniformly around the slot, and the first spindle of the support frame has a plurality of notches formed at the periphery of the first spindle and corresponding to the second protrusions respectively.

6. The rotary hanging tag of claim 5, wherein the hanging plate includes a hanging hole formed thereon.
